(19) United States
(12) Patent Application Publication
(10) Pub. No.: US 2025/0326586 A1
(43) Pub. Date: Oct. 23, 2025

(54) MODULAR CONTAINER-PROCESSING INSTALLATION

(71) Applicant: KRONES AG, Neutraubling (DE)

(72) Inventors: Bernhard WESS, Neutraubling (DE); Veronika TESAR, Bischofsmais (DE); Katarina MEHRINGER, Regensburg (DE); Elisabeth PILNEY, Lappersdorf (DE)

(21) Appl. No.: 18/871,348

(22) PCT Filed: May 30, 2023
(86) PCT No.: PCT/EP2023/064421

§ 371 Date: Dec. 3, 2024

(30) Foreign Application Priority Data
Jun. 3, 2022 (DE) 10 2022 114 144.6

(51) Int. Cl. B65G 37/02; B65C 9/02; B65G 43/02; B67C 3/00; B67C 7/00

(52) U.S. Cl. CPC B65G 37/02; B65C 9/02; B65G 43/02; B67C 3/007; B67C 7/002; B65G 2201/0235; B65G 2203/0275; B65G 2207/30

(57) ABSTRACT

The invention relates, inter alia, to a modular container-processing installation comprising a conveyor main module-which is arranged for conveying containers through the modular container-processing installation, and a plurality of sub-module interfaces. The container-processing installation also comprises a plurality of container-processing sub-modules which can be coupled to and uncoupled from the plurality of sub-module interfaces The container-processing installation-also comprises a control system which, in a self-configuring manner, is configured to automatically adapt the operation of the modular container-processing installation depending on coupling and/or uncoupling of at least one of the plurality of container-processing sub-modules.

### TECHNICAL FIELD

The invention relates to a modular container-processing installation, a method for producing a modular container-processing installation and a method for operating a modular container-processing installation.

### TECHNICAL BACKGROUND

In practice, the planning and commissioning of complex production installations, such as container-processing installations, which comprise a plurality of interconnected machines, still proves to be challenging, time-consuming and inflexible.

WO 2014/016091 A1 describes a production installation for producing and filling containers, and a corresponding method. Modular processing units with stationary work modules and handling devices are provided for handling the containers between a container inlet of the processing unit and a container outlet of the processing unit, and for positioning the containers in the work module. The handling devices are configured in such a way that the processing units can be exchanged individually, and at least two identical processing units are provided, over which the containers can be distributed in a targeted manner.

DE 10 2019 126 402 A1 discloses an apparatus for processing containers, comprising at least one transport device for transporting the containers, comprising a handling apparatus for transferring containers from the transport device in a transfer region and for delivering these containers to the transport device in a delivery region, comprising at least one further handling apparatus for transferring containers from the transport device in a further transfer region and for delivering these containers to the transport device in a further delivery region. At least one processing station is assigned to each handling apparatus. The processing stations are filling devices which at least partially fill the containers with a liquid, and these filling devices are arranged in a stationary manner with respect to the transport paths.

The invention is based on the object of creating an improved container-processing installation which in particular makes possible simplified commissioning, adaptation and retrofitting.

### SUMMARY OF THE INVENTION

The object is achieved by the features of the independent claims. Advantageous developments are specified in the dependent claims and the description.

One aspect of the present disclosure relates to a modular container-processing installation comprising a conveyor main module arranged for conveying containers through the modular container-processing installation and a plurality of (e.g., standardized) sub-module interfaces. The modular container-processing installation further comprises a plurality of container-processing sub-modules which can be coupled to the plurality of sub-module interfaces (e.g., for commissioning) and uncoupled from them (e.g., for decommissioning) (e.g., one container-processing sub-module can be coupled to each sub-module interface, respectively), preferably automatically, e.g., using a driverless transport vehicle. The modular container-processing installation further comprises a (e.g., central or distributed) control system which is self-configuring for automatically adapting an operation of the modular container-processing installation depending on a coupling of at least one of the plurality of container-processing sub-modules to at least one of the plurality of sub-module interfaces and/or on a uncoupling of at least one of the plurality of container-processing sub-modules from at least one of the plurality of sub-module interfaces.

Advantageously, self-configuration can allows the commissioning of the container-processing installation to be significantly shortened and thus the start of production to be brought forward. This also applies to conversions, retrofitting, replacement and dismantling of modules as well as to various changes in the production process such as, for example, changing the container format, the product or the adaptation of all types of production parameters such as, for example, the output of the installation. No lengthy setup processes with user assistance are necessary, as the control system can take over the setup or adaptation of the setup itself when it detects that a module is being coupled or uncoupled. The control system thus makes possible an almost “plug and play” or “plug and produce” functionality. The modules can already be put into operation independently before the first coupling to one of the plurality of sub-module interfaces. With the self-configuration, the control system can, for example, determine the basic configuration and specific parameters for the operation of the respectively coupled module. In this case, the ability to self-configure works synergistically with the modularity of the container-processing installation, as it makes possible a plurality of different modular configurations, without the need to develop a specific control configuration and a specific process flow with corresponding program code for each of these configurations in advance. Despite a wide range of requirements and configurations, the modular container-processing installation can therefore always be put into operation or, for example, converted or retrofitted in the shortest possible time, if necessary even during operation. It is possible that a test commissioning of the container-processing installation or parts thereof at the manufacturer's site may be dispensed with, as a result of which production costs are reduced. The commissioning itself requires fewer technical experts. The flexible, modularly adaptable container-processing installation also makes possible a flexible and short-term production planning, so that costs and expenses for storage can be reduced.

Preferably, the term “self-configuring” may refer to a control setup process that is carried out without a manual setup process or with an automatic control setup process.

Preferably, the control system is further self-configuring for automatically adapting an operation of the modular container-processing installation depending on a change in production data, production specifications and/or the occurrence of a malfunction.

In one embodiment, the modular container-processing installation further comprises a plurality of container-processing main modules which can be coupled to and uncoupled from a plurality of (e.g., standardized) main module interfaces of the conveyor main module, preferably automatically, e.g. using a driverless transport vehicle. The plurality of container-processing main modules each comprises at least one of the plurality of sub-module interfaces and a conveying sub-module which is connected or connectable to the conveying main module for receiving the containers from the conveying main module and for transferring the containers back to the conveying main module (e.g., transfer from container clamp to container clamp) (and is configured, for example, for conveying the containers to the container-processing sub-modules coupled to the respective sub-module interfaces). Preferably, the control system can further be self-configuring for automatically adapting an operation of the modular container-processing installation depending on a coupling of at least one of the plurality of container-processing main modules to at least one of the plurality of main module interfaces and/or on a uncoupling of at least one of the plurality of container-processing main modules from at least one of the plurality of main module interfaces.

This advantageously also makes it possible to construct comparatively complex container-processing installations in a modular manner, wherein the advantages of self-configuration explained above can also be used here. Preferably, the container-processing main modules can each be equipped with functionally identical and/or functionally related container-processing sub-modules, so that preferably different functional units can be provided within the modular container-processing installation.

In a further embodiment, the control system is configured to receive production order information for processing the containers. Preferably, the control system can further be configured to automatically adapt the operation of the modular container-processing installation and/or a respective coupling and uncoupling of the plurality of container-processing sub-modules to the plurality of sub-module interfaces (and preferably of the container-processing main modules to the main module interfaces) depending on the received production order information. This advantageously makes flexible production possible, as a result of which, for example, very different container formats can also be processed in the container-processing installation. It is possible, for example, that at least one coupled container-processing sub-module for a specific production order or for a specific batch remains coupled but unused.

Preferably, the control system can be configured to further adapt a machine power, a machine speed, a production parameter and/or a module parameter depending on the received production order information.

In one embodiment, the control system is configured to generate a movement path of the containers through the modular container-processing installation including at least a portion of the plurality of container-processing sub-modules (and preferably the container-processing main modules) when automatically adapting the operation, and to control a movement of the containers according to the generated movement path.

In a further embodiment, the control system is configured to adapt operating parameters of the conveyor main module and/or the plurality of container-processing sub-modules (and/or the container-processing main modules) when automatically adapting the operation.

In a further embodiment, the control system is configured to automatically adapt the operation and/or the respective coupling and uncoupling depending on empirical data in which previous operations of the modular container-processing installation and/or other container-processing installations are stored.

In a variant, the modular container-processing installation m further comprises a parking station and (at least) one driverless transport vehicle for transporting at least one of the plurality of container-processing sub-modules between the parking station and the plurality of sub-module interfaces. Alternatively or additionally, the driverless transport vehicle can be configured to transport at least one of the plurality of container-processing main modules between the parking station and the plurality of main module interfaces.

In a variant, the control system is configured to control, depending on received production order information, a transport of at least one of the plurality of container-processing sub-modules between the parking station and at least one of the plurality of sub-module interfaces for coupling or uncoupling the respective container-processing sub-module, using the driverless transport vehicle.

In a further variant, the control system is configured to control, depending on received production order information, using the driverless transport vehicle, a transport of at least one of the plurality of container-processing main modules between the parking station and at least one of the plurality of main module interfaces for coupling or uncoupling the respective container-processing main module.

In one embodiment, the control system is configured to generate and/or receive fault information indicating a predicted or current defect of a component and, depending on the fault information, to control an automatic repair or an automatic replacement of the component (e.g., using a stationary or mobile service robot) and/or a software code assigned to the component. Alternatively or additionally, the operation of the modular container-processing installation can be automatically adapted such that the component is bypassed by the containers and/or a software code assigned to the component is bypassed, preferably while the component or the software code assigned to the component is automatically replaced or repaired. Alternatively or additionally, the control system may control an automatic uncoupling of the container-processing sub-module (and/or container-processing main module) that comprises the component. The container-processing installation can therefore advantageously react automatically to faults. Accordingly, production can be carried out with less waste and fewer faults that require machine stoppage, thereby increasing overall effectiveness of the installation.

In a further embodiment, the plurality of container-processing sub-modules comprises at least one of the following:
at least one labeling sub-module for labeling the containers;
at least one testing sub-module for testing the containers;
at least one printing sub-module for printing on the containers;
at least one cleaning sub-module for cleaning the containers;
at least one filling sub-module for filling the containers;
at least one closing sub-module for closing the containers;
at least one heating sub-module for heating preforms of the containers;
at least one molding sub-module for forming the containers from preforms, preferably using stretch blowing;
at least one turning sub-module for turning the containers;
at least one cooling sub-module for cooling the containers;
at least one coating sub-module for coating the containers (e.g., on the inside);
at least one pasteurization module for pasteurizing the containers;
at least one drying module for drying the containers;
at least one grouping module for grouping the containers;
at least one packing module for packing the containers;
at least one palletizing module for palletizing the containers;
at least one depalletizing module for depalletizing the containers;
at least one unpacking module for unpacking the containers; and
at least one dating module for dating the containers.

In a further embodiment, at least one testing sub-module and at least one labeling sub-module and/or printing sub-module are included, which are jointly coupled to a plurality of sub-module interfaces of one of the plurality of container-processing main modules, preferably for forming a container equipping main module. Advantageously, these functionally related sub-modules can thus be combined in a container-processing main module for forming a functional unit.

In a further embodiment, a plurality of filling sub-modules and a plurality of closing sub-modules are included, which are jointly coupled to a plurality of sub-module interfaces of one of the plurality of container-processing main modules, preferably for forming a container filling and closing main module. Advantageously, these functionally related sub-modules can be combined in a container-processing main module for forming a functional unit.

In a further embodiment, a plurality of heating sub-modules and a plurality of molding sub-modules are included, which are jointly coupled to a plurality of sub-module interfaces of one of the plurality of container-processing main modules, preferably for forming a container-producing main module. Advantageously, these functionally related sub-modules can thus be combined in a container-processing main module for forming a functional unit.

In one embodiment, the control system comprises a plurality of decentralized control units assigned to the conveyor main module and/or the plurality of container-processing sub-modules (and/or preferably the plurality of container-processing main modules), and optionally a central data source. Preferably, the plurality of decentralized control units and the optional central data source are configured to jointly coordinate the adaptation of the operation of the modular container-processing installation when coupling and/or uncoupling one of the plurality of container-processing sub-modules (and/or when coupling and/or uncoupling one of the plurality of container-processing main modules) for self-configuration of the control system. For example, parameters and/or mechatronics (e.g., automatic format part changeover) can be adapted. Preferably, type-dependent data, production-dependent data and/or system data can be stored in the central data source.

In a further embodiment, the plurality of sub-module interfaces each comprises an electrical connection, a communication connection, a fluid connection and/or a mechanical connection. Alternatively or additionally, the plurality of sub-module interfaces can for example be identical in construction.

Optionally, the plurality of sub-module interfaces can be arranged one after the other in series along a course of the conveyor sub-module of the respective container-processing main module.

It is possible that the plurality of main module interfaces each comprises an electrical connection, a communication connection, a fluid connection and/or a mechanical connection. Alternatively or additionally, the plurality of main module interfaces can be identical in structure. Alternatively or additionally, the plurality of main module interfaces are arranged one after the other in series along a course of the conveyor main module.

In a variant, the conveyor main module is located centrally in the container-processing installation. Alternatively or additionally, the conveyor main module is configured as a transport carousel, as a long stator or short stator linear drive conveyor, as a planar drive conveyor, as a belt conveyor or as a neck handling conveyor. Alternatively or additionally, the plurality of container-processing sub-modules and/or the plurality of container-processing main modules are arranged in a manner distributed around the conveyor main module.

Optionally, the plurality of conveyor sub-modules can each be configured as bypass sections to a portion of the conveyor main module, as carousels or as satellites.

Preferably, in each case a plurality of the container-processing sub-modules is arranged in a manner distributed around the conveyor sub-module of the respective container-processing main module.

A further aspect of the present disclosure relates to a method for producing a modular container-processing installation, preferably as disclosed herein, using a modular construction system. The method comprises a (e.g., computer-aided) selection of a conveyor main module from a plurality of different conveyor main modules of the modular construction system, preferably using a graphical user interface. The plurality of different conveyor main modules can each be arranged for conveying containers through the modular container-processing installation. The plurality of different conveyor main modules each comprises a plurality of main module interfaces. The method further comprises a (e.g., computer-aided) selection of a plurality of container-processing main modules from a plurality of different container-processing main modules of the modular construction system, preferably using the graphical user interface. The plurality of different container-processing main modules can be coupled to the plurality of main module interfaces (e.g., automatically using a driverless transport vehicle). The plurality of different container-processing main modules each comprises a plurality of sub-module interfaces. The plurality of different container-processing main modules each comprises a conveyor sub-module that can be connected to the selected conveyor main module for receiving the containers from the selected conveyor main module and for transferring the containers back to the selected conveyor main module. The method further comprises a (e.g., computer-aided) selection of a plurality of container-processing sub-modules (e.g., in each case) from a plurality of different container-processing sub-modules (e.g., for the selected container-processing main modules) of the modular construction system, preferably using the graphical user interface. The plurality of different container-processing sub-modules can be coupled to the plurality of sub-module interfaces (e.g., automatically using a driverless transport vehicle). The method further comprises a (e.g., computer-aided) assembling (and e.g., constructing) the modular container-processing installation from the selected conveyor main module, the selected main container-processing modules and the selected container-processing sub-modules. Advantageously, the method can achieve the same advantages as already described with reference to the modular container-processing installation.

It is possible that (among other things) a plurality of identical container-processing sub-modules and/or a plurality of identical container-processing main modules are selected.

Preferably, the different container-processing sub-modules can differ in function, structure and/or configuration. Alternatively or additionally, the various container-processing main modules can differ in function, structure and/or configuration.

It is possible that the method further comprises a (e.g., computer-aided) selection of a parking station and/or a driverless transport vehicle for transporting the plurality of container-processing sub-modules and/or the container-processing main modules, preferably using a graphical user interface.

A further aspect of the present disclosure relates to a method for operating a modular container-processing installation, preferably as disclosed herein, comprising automatically adapting an operation of the modular container-processing installation by self-configuring the control system depending on a coupling and/or uncoupling of at least one of the plurality of container-processing sub-modules. Optionally, the method can further comprise, for example, automatically adapting an operation of the modular container-processing installation by self-configuring the control system depending on a coupling and/or uncoupling of at least one of the plurality of main container-processing modules. Advantageously, the method can achieve the same advantages as already described with reference to the modular container-processing installation.

Preferably, the method can further comprise transporting one of the plurality of container-processing sub-modules between a parking station and one of the plurality of sub-module interfaces using a driverless transport vehicle controlled by the control system depending on received production order information and/or received fault information.

Optionally, the method can further comprise transporting one of the plurality of container-processing main modules between a parking station and one of the plurality of main module interfaces using a driverless transport vehicle controlled by the control system depending on received production order information and/or received fault information.

Preferably, the container-processing installation can be configured for the production, cleaning, coating, testing, filling, closing, labeling, printing and/or packing of containers for liquid media, preferably beverages or liquid foodstuffs.

For example, the containers can be configured as preforms, bottles, cans, canisters, cartons, vials, etc.

Preferably, the term “control unit” and “control system” can refer to electronics (e.g., comprising microprocessor(s) and data memory) that can perform control tasks and/or regulating tasks and/or processing tasks depending on the configuration. Although the term “control” is used herein, this can also comprise or be understood as “closed-loop control” or “control with feedback” and/or “processing” as appropriate.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 is a schematic representation of a modular construction system for a modular container-processing installation;

FIG. 2 is a schematic representation of a modular container-processing installation according to an embodiment of the present disclosure;

FIG. 3 is a schematic representation of a modular container-processing installation according to an embodiment of the present disclosure;

FIG. 4 is a schematic representation of a modular container-processing installation according to an embodiment of the present disclosure; and

FIG. 5 is a schematic illustration of a communication network of a modular container-processing installation.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

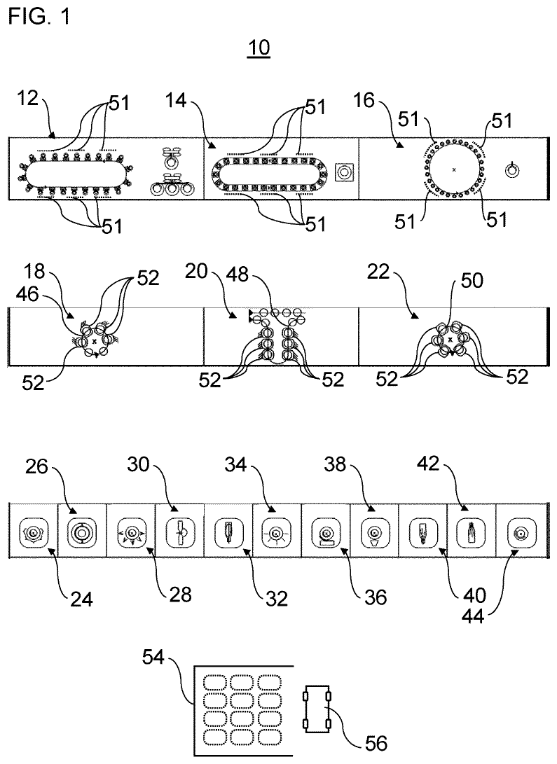

FIG. 1 shows a modular construction system 10 for producing a container-processing installation. The construction system 10 comprises a plurality of different conveyor main modules 12-16, a plurality of different container-processing main modules 18-22 and a plurality of different container-processing sub-modules 24-44.

The conveyor main modules 12-16 can be arranged for conveying containers through a container-processing installation. Preferably, the conveyor main modules 12-16 can each be arranged centrally in the container-processing installation. The conveyor main modules 12-16 can be configured differently.

For example, the conveyor main module 12 can be configured as a long stator or short stator linear drive conveyor. The conveyor main module 12 can comprise a plurality of movement apparatuses or movers or shuttles for container transport. Each movement apparatus can transport one or more containers. The movement apparatuses can be guided along a preferably continuous guide track, for example using rollers or sliding shoes. The movement apparatuses can be driven along the guide track independently of one another, using magnetic interaction between permanent magnets and electromagnets (=short stator or long stator).

The conveyor main module 14 can be configured as a conveyor belt. The conveyor belt can support the containers on the ground using a circulating conveyor belt and transport them. The conveyor belt can be configured, for example, as a continuous belt or as a mat chain, etc. Alternatively, the conveyor main module 14 can be configured, for example, for continuous container transport in neck handling, e.g. using a container clamp.

The conveyor main module 16 can be configured as a transport star or as a transport carousel. The transport star can transport the containers in a manner rotating about a central axis. The transport star can hold the containers during transport, for example with clamps, grippers and/or (e.g., rotating) plates.

It is possible, for example, that another conveyor main module is configured as a planar drive conveyor or a planar motor conveyor. In this case, a plurality of movement apparatuses or movers or shuttles for container transport with at least two degrees of freedom (x-direction and y-direction) can be moved independently of one another over a preferably planar drive surface using magnetic interaction with the drive surface. It is also possible for there to be a lifting movement (z-direction) and/or a tilting movement of the movement apparatuses relative to the drive surface using the magnetic interaction. Preferably, the drive surface can be oriented horizontally or vertically. Each movement apparatus can transport one or more containers.

The conveyor main modules 12-16 each comprise a plurality of main module interfaces 51 (shown only schematically in FIG. 1). The main module interfaces 51 can be arranged in a manner distributed around the conveyor main modules 12-16, preferably on an outer periphery of the respective conveyor main module 12-16. One container-processing main module 18-22 can be coupled to each main module interface 51. The main module interfaces 51 can, for example, each comprise an electrical connection, a communication connection, a fluid connection and/or a mechanical connection. Preferably, the main module interfaces 51 can be identical in construction. The main module interfaces 51 can be arranged one after the other in series along a course of the respective conveyor main module 12-16.

The containers can be processed in the container-processing main modules 18-22. The container-processing main modules 18-22 can be coupled (docked) to the main module interfaces 51 of the conveyor main modules and uncoupled (undocked) from them, preferably automatically.

The container-processing main modules 18-22 can each comprise a conveyor sub-module 46, 48, 50 for container transport and a plurality of sub-module interfaces 52. A plurality of the container-processing sub-modules 24-44 can be coupled to the sub-module interfaces 52, preferably one container-processing sub-module 24-44 per sub-module interface 52. Using the sub-module interfaces 52, the container-processing main modules 18-22 can be equipped with respectively desired container-processing sub-modules 24-44.

The conveyor sub-modules 46, 48, 50 can transport the containers and/or the container-processing sub-modules 24-44, with which the respective container-processing main module 18-22 is equipped. The conveyor sub-modules 46, 48, 50 can be connectable for receiving the containers from one of the conveyor main modules 12-16 and (after container processing) for transferring the containers back to the conveyor main module 12-16. The conveyor sub-modules 46, 48, 50 can be configured differently.

The conveyor sub-module 46 can, for example, be configured as a clocked satellite, e.g. a clocked transport star or carousel. The conveyor sub-module 48 can, for example, be configured as a bypass section for a portion of the respective conveyor main module. The conveyor sub-module 48 can preferably be configured as a long stator or short stator linear drive or planar drive conveyor. The conveyor sub-module 50 can, for example, be configured as a continuously operated transport star or carousel.

The sub-module interfaces 52 can be arranged in a manner distributed around the conveyor sub-modules 46-50. In each case one container-processing sub-module 24-44 can be coupled (docked) to and uncoupled (undocked) from each of the sub-module interfaces 52. The sub-module interfaces 52 can, for example, each comprise an electrical connection, a communication connection, a fluid connection and/or a mechanical connection. Preferably, the sub-module interfaces 52 can be identical in construction. The sub-module interfaces 52 can be arranged one after the other in series along a course of the respective conveyor sub-module 46-50.

The container-processing sub-modules 24-44 can each be coupled to one of the sub-module interfaces 52. Depending on the structure, the container-processing sub-modules 24-44 can be stationary or moved by the respective conveyor sub-module 46-50. The container-processing sub-modules 24-44 can be carried by supports of the container-processing main modules 18-22.

The container-processing sub-modules 24-44 can be configured differently. The container-processing sub-modules 24-44 can be divided into basic functions such as coating, labeling, filling, etc.

For example, the heating sub-module 24 can be configured for heating preforms for producing the containers. The molding sub-module 26 can be configured for molding the containers. For example, the molding sub-module 26 can (e.g., stretch-) blow-molded containers from preforms. The cooling sub-module 28 can be configured for cooling the containers. The turning sub-module 30 can be configured for turning (invert) the containers or placing them upside down. The coating sub-module 32 can be configured for coating the containers (e.g., on the inside). The printing sub-module 34 can be configured for printing on the containers, e.g. using a direct printing process. The labeling sub-module 36 can be configured for labeling the containers. The testing sub-module 38 can be configured for inspecting or testing the containers. The cleaning sub-module 40 can be configured for (e.g., overhead) cleaning of the containers. The filling sub-module 42 can be configured for filling the containers, e.g. with a liquid or pasty medium. The closing sub-module 44 can be configured for closing the containers, e.g. with a lid, a screw cap, a cork or a crown cap.

In order to improve the efficiency of the modular construction system 10, the production or provision of the modules 12-50 can preferably be adapted depending on the frequency of use in container-processing installations. Thus, the modules 12-50 and also their respective components can each be provided for example as basic modules, order-related modules or special modules.

Those modules from modules 12-50 that are versatile, are frequently required and, for example, comprise easily predictable sales figures, can be provided as basic modules. Ideally, basic modules can be pre-produced according to sales forecasts and easily retrieved when an order is placed. Preferably, their mechatronic structure is such that after retrieval from the warehouse, no or very few adaptations have to be made before a basic module can be connected to other modules.

Those modules from modules 12-50 that are required for special processes/functions and, for example, have sales figures that can be planned only with difficulty, can be provided as order-related modules. Order-related modules can preferably be manufactured specifically for the order. In contrast to special modules, their range of functions can be developed ready-for-series production and be permanently included in the product portfolio.

The basic modules and preferably also the order-related modules can be pre-assembled by the manufacturer according to forecast data, regardless of the order and object, as a result of which production costs can be reduced, delivery times can be shortened and the ability to react to short-term changes can be improved.

Those modules from modules 12-50 that concern unfinished variants of modules or modules with completely new functions can be provided as special modules. For special modules, an order development can be carried out, the effects of which on the order can ideally be communicated to the purchaser of the installation during the planning of the container-processing installation, e.g. regarding the possibilities and limitations of the special module, additional costs, increase in delivery time, etc., as far as known or estimable.

For example, a container-processing main module 22 configured as a container filling main module can comprise as a basic module the conveying sub-module 50 configured as a carousel with a predefined pitch circle. The filling sub-modules 42 with which the container filling main module is equipped can be order-related modules with filling valves, etc. adapted for the respective application (e.g., with or without load cell, fill level probe and/or aseptic filling). As a further order-related module, the container filling main module can, for example, be equipped with a media supply module for supplying the filling sub-modules 42 with a filling medium or product. The media supply module can optionally further supply compressed air to the filling sub-modules 42 and/or provide a vacuum source for evacuating the containers via the filling sub-modules 42. The container filling main module 22 can furthermore also be equipped with a special tank module for the filling medium, which is adapted as a special module to the spatial conditions of the desired production location.

It is understood that the example explained above is transferable to other container-processing main modules, such as a container labeling main module.

For constructing or producing a modular container-processing installation, a conveyor main module can preferably be selected from the plurality of conveyor main modules 12-16 of the modular construction system 10. In addition, a plurality of container-processing main modules are selected from the container-processing main modules 18-22 and a plurality of container-processing sub-modules 24-44 are selected for equipping each of the selected container-processing main modules. The container-processing installation is then modularly assembled and constructed from the selected conveyor main module, the selected container-processing main modules and the selected container-processing sub-modules.

The selected conveyor main module 12 and the selected container-processing main modules 18-22 coupled to it (without the container-processing sub-modules 24-44) can form a functionally neutral or functionally adaptable basic structure of a modular container-processing installation. By coupling the selected container-processing sub-modules 24-44, an order-related container-processing installation can be provided. The container-processing sub-modules 24-44 can also be inserted into the basic structure depending on a production order (or production order information). Depending on the product, the configuration of the container-processing installation can be changed quickly and easily.

The selection of the conveyor main modules 12-16, the container-processing main modules 18-22 and the container-processing sub-modules 24-44 can preferably be carried out computer-aided in a graphical user interface on a computer. Using the graphical user interface, different information can preferably be entered and retrieved, e.g. data on preforms, containers, container formats, labels and/or closures, etc. Optionally, container-processing installations that are already completely or partially preconfigured, e.g. from previous sessions or orders, can also be loaded into the graphical user interface. Customers can therefore develop or refine their specific requirements directly in the graphical user interface.

The graphical user interface can then be used to put together the desired configuration for the container-processing installation. Optionally, details or special customer requests can also be customized by product specialists. It is also possible that the spatial installation conditions can be taken into account in the graphical user interface when planning the container-processing installation. For example, a production hall for the container-processing installation can be measured using a 3D scan and the data can then be loaded into the graphical user interface. The dimensions of the production hall can, for example, also be available as CAD data and loaded into the graphical user interface.

When planning the container-processing installation in the graphical user interface, late changes to modules can also be taken into account due to the modular nature of the modular construction system 10. It is also possible that—if the container-processing installation is planned with correspondingly variable modules—the container-processing installation provides a certain variability for processing different containers.

The graphical user interface can support the user when planning the container-processing installation, for example by displaying additional information for certain actions or changes relating to the container-processing installation. For example, it can be shown what impact a particular change has on constraints such as size of the installation, costs, delivery date, expandability, flexibility and/or performance, etc. In this connection, special requests from customers can also be accommodated, wherein the effects on the order conditions are preferably directly visible and clearly communicated via the graphical user interface.

The graphical user interface can also be used to actively support the user in planning, e.g. by displaying suggestions for improvement, pointing out other options and/or features, etc., so that the user can advantageously put together the optimal container-processing installation for his application in a modular manner.

Based on the data of the container-processing installation compiled in the graphical user interface, the manufacturer of the installation can in all other respects also prepare an offer for the corresponding customer particularly quickly, wherein corresponding time and resource savings result compared to conventional quotation preparation. For the manufacturer, this can also result in the advantage of easier planning of the required quantities of machines and installations along with fast order processing through standardized modules.

After the container-processing installation has been digitally assembled in the graphical user interface, the container-processing installation can be physically assembled and installed using the modular construction system 10. Autonomous and, where appropriate, semi-autonomous, modules can be put into operation before delivery, so that they are already prepared for mechanical, control and software integration into the customer's system. In this case, as already explained, the individual modules can be provided as basic modules, order-related modules or special modules.

The respective container-processing installation can comprise a (e.g., central or distributed) control system. The control system can advantageously allow for the respective container-processing installation to be controlled in a self-configuring manner, as described in detail below by way of example. Optionally, the control system can also allow for the respective container-processing installation to be self-organizing, self-optimizing, self-protecting, self-healing and/or self-explanatory or to be controlled, as is also described in detail below by way of example.

With regard to the self-configuration capability, the control system can automatically adapt operation of the respective container-processing installation depending on coupling at least one of the plurality of container-processing sub-modules 24-44 to at least one of the sub-module interfaces 52 and/or uncoupling at least one of the plurality of container-processing sub-modules 24-44 from at least one of the sub-module interfaces 52. Optionally, the control system can automatically adapt the operation of the respective container-processing installation depending on a coupling of at least one of the plurality of container-processing main modules 18-22 to at least one of the main module interfaces 51 and/or an uncoupling of at least one of the plurality of container-processing main modules 18-22 from at least one of the main module interfaces 51.

The ability for self-configuration can be implemented, for example, in that a respective module 12-50 “knows” its own configuration, e.g. in the form of configuration information stored in a respective assigned control unit, and can transmit this configuration information to the other modules 12-50 of the respective container-processing installation when coupled. Alternatively, each module can also receive configuration information by exchanging it with other modules 12-50 of the respective container-processing installation. In terms of software, this can be implemented in such a way that parameter sets and functions for a specific type of production or for the production of a specific product can be loaded fully automatically from a suitable source in each case. As a result, the mechanics of a module 12-50 can optionally also be adapted to the respective production mode, if possible and sensible.

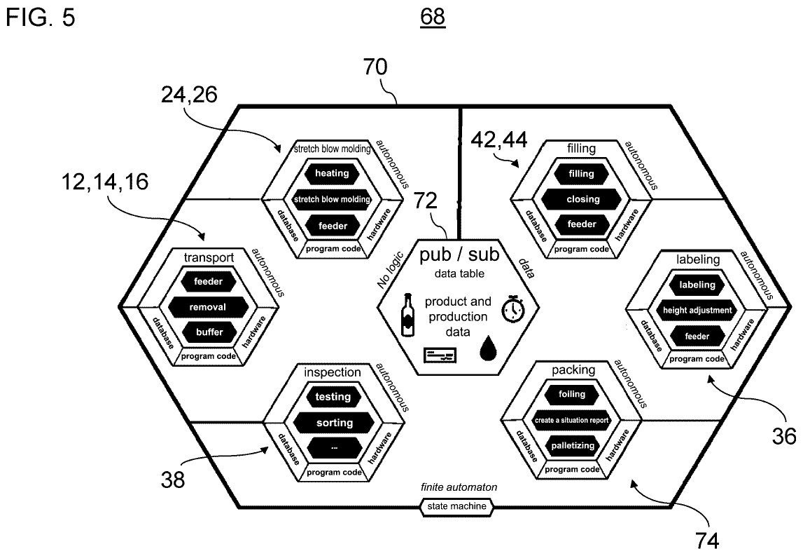

Preferably, the control system of the respective container-processing installation can be configured in a decentralized or distributed manner. The control system can, for example, comprise decentralized control units which are assigned to the respectively selected conveyor module 12-16 and 46 to 50 as well as to the respectively selected processing modules 18-44. For example, each module 12-50 of the respective container-processing installation can comprise its own decentralized control unit. The decentralized control units can communicate with each other. The control system can optionally also comprise a central data source 72 (see FIG. 5) with which the decentralized control units can communicate and/or specifically retrieve and change information.

The decentralized control units and the central data source 72 can jointly coordinate the adaptation of the operation of the respective container-processing installation when coupling and/or uncoupling one of the plurality of modules 18-50 for self-configuration of the control system. In this case, for example a control unit assigned to a coupling module can transmit information regarding its own (e.g., software and/or hardware) configuration to the other decentralized control units and/or the central data source 72. Alternatively or additionally, for example a control unit assigned to a coupling module can receive information regarding the (e.g., software and/or hardware) configuration of the container-processing installation and/or other modules 12-50 from the central data source 72 and/or other decentralized control units.

The ability to self-configure the control system can already play a crucial role during the assembly of the container-processing installation. The final assembly of the container-processing installation is carried out directly at the customer's premises. The self-configuration allows for the assembled modules 12-50 to automatically detect and communicate with each other. Interfaces may be available for the integration of third-party machines that do not come from the modular construction system 10. The container-processing installation created from the modular construction system 10 can be put into operation in a very short time. In order to even further accelerate bringing into operation, a virtual commissioning of the process, control system and mechanics can also be carried out beforehand based on a virtual twin of the container-processing installation, which has been compiled in the graphical user interface.

With regard to the ability to self-organize, the control system can control a process, work or program-related operating sequence for operating the respective container-processing installation, preferably taking into account all coupled modules 18-50. Thus, for example higher-level production order information can be received by the control system, and each module 12-50 of the respective container-processing installation can perform its function for solving the task specified by the production order information. This means that it is not necessary to plan the composition of the respective container-processing installation and the timing of functions, to program them in advance and to completely revise them in the event of changes or optimization. Instead, the control system can automatically adapt the current operation of the respective container-processing installation to a current configuration (e.g., which modules 18-50 are coupled?).

The modular construction system 10 can optionally further comprise a parking station or a module station 54 and at least one driverless transport vehicle (AGV—automated guided vehicle) 56.

In the parking station 54, uncoupled container-processing sub-modules 24-44 of a respective container-processing installation that are not currently in use can be temporarily stored. It is also possible that one or more uncoupled container-processing main modules 12-16 of a respective container-processing installation that are not currently in use can be temporarily stored in the parking station 54. The modules 18-22 and/or 24-44 temporarily stored in the parking station 54 can be used, for example, when coupled container-processing sub-modules 24-44 that require repair or maintenance are to be replaced and/or when they are required to fulfill received production order information, e.g. for a different product, a different container format or a different processing.

Using the driverless transport vehicle 56, the container-processing sub-modules 24-44 of a respective container-processing installation can be transported between the parking station 54 and the sub-module interfaces 52. Alternatively or additionally, the container-processing main modules 18-22 of a respective container-processing installation can be transported between the parking station 54 and the main module interfaces 51 using the driverless transport vehicle 56.

The driverless transport vehicle 56 can be controlled by the control system of the respective container-processing installation. Alternatively or additionally, the transport vehicle 56 can also be assigned its own decentralized control unit located in the communication network. For example, the control system of the respective container-processing installation can receive production order information for processing the containers. The production order information can, for example, be entered by a user or received via a communication interface. The production order information can, for example, specify how the containers or which containers are to be processed, e.g. in relation to a desired filling product, a desired closure, a desired container format, desired labeling, desired printing and/or a desired packaging, etc. Optionally, the production order information can, for example, also specify a number of containers to be processed.

Depending on the production order information received, the control system can control the driverless transport vehicle 56 in such a way that all previously uncoupled container-processing sub-modules 24-44 and/or container-processing main modules 18-22 of the respective container-processing installation that are still necessary to fulfill the production order information are transported from the parking station 54 to the sub-module interfaces 52 or the main module interfaces 51 using the driverless transport vehicle 56 and optionally also coupled (e.g., automatically). Alternatively, if desired, at least one previously coupled container-processing sub-module 24-44 and/or container-processing main module 18-22 of the respective container-processing installation that is not necessary for fulfilling the production order information can be uncoupled (e.g., automatically) and transported to the parking station 54 using the driverless transport vehicle 56.

It is understood that for constructing or producing a modular container-processing installation, in addition to the modules 12-44, the parking station 54 and the driverless transport vehicle 56 can also be selected.

Alternatively or in addition to the driverless transport vehicle 56, it is also possible that the container-processing sub-modules 24-44 can be manually coupled, uncoupled and/or transported. It goes without saying that in this case aids such as vehicles (e.g., an industrial truck) can also be used.

With regard to the ability to self-optimize, the control system can be configured in such a way that a database is created and used. For example, the production order information can be used to bring target values of the order into the control system. Due to the self-configuration, the output parameters or operating parameters can be known for each module 12-50, which can be adjusted fully automatically by the control system during operation in order to optimally fulfill the task. For example, signals from corresponding sensors, along with monitoring of process parameters and comparison with a database of empirical values and optimization measures from the past can serve as a reference for such optimization processes. It is possible to make this knowledge base accessible to a plurality of container-processing installations worldwide and to gradually enrich it with newly acquired data, thus creating a continuous improvement process. The container-processing installation can also advantageously determine its optimal production process taking into account criteria such as minimum energy and media consumption.

In particular, it may be possible for the control system of the respective container-processing installation to automatically adapt its operation depending on the production order information received for processing the containers. For this purpose, the control system can, for example, generate a movement path of the containers through the respective container-processing installation, including at least some of the plurality of container-processing main modules 18-22 and/or container-processing sub-modules 24-44. A movement of the containers through the container-processing installation can then be controlled by the control system according to the generated movement path. Adapting the operation can also comprise adjusting the operating parameters of modules 12-50. It is also possible for the control system to use experience data stored from previous operations of the respective container-processing installation and/or other container-processing installations for adapting the operation.

With regard to the ability to protect itself, the control system of the respective container-processing installation can be configured to detect current or impending errors or defects based on received information. If an error is detected, the control system can initiate corresponding protective measures in order to reduce the extent of damage as much as possible. Ideally, there is no need for an operator to take any action. The control system can receive the information, for example, from sensors and/or an operating parameter monitor. When evaluating the information, the control system can, for example, also access a database with empirical values.

With regard to the ability for self-healing, the control system can be configured, based on received information, to adapt the operation of the respective container-processing installation in the event of errors or defects occurring which, for example, are not predictable or unavoidable, such that the respective container-processing installation can continue to be operated for processing the containers until the defect can be repaired and/or during which the defect can be repaired during ongoing operation. The control system can receive the information, for example, from sensors and/or an operating parameter monitor. When evaluating the information, the control system can, for example, also access a database with empirical values.

In particular, it may be possible that the control system of the respective container-processing installation can receive fault information. The fault information can, for example, indicate a predicted or current defect of a component. The component can, for example, be included in one of the components 12-56. The information can, for example, be transmitted to the control system from sensors in the respective container-processing installation. The sensors can monitor the component. The sensors can, for example, comprise physical sensors, e.g. optical sensors. Alternatively or additionally, the sensors can comprise virtual sensors, which can, for example, use recorded operating data to determine a current or impending defect in a component. Alternatively or additionally, the information may be entered by a user and/or received via a communication interface.

Based on the received fault information, the control system can, for example, control an automatic repair or an automatic replacement of the component. For automatic replacement, the control system can, for example, control the driverless transport vehicle 56. Alternatively or additionally, based on the received fault information, the control system can automatically adapt the operation of the respective container-processing installation for bypassing the component specified in the fault information, preferably while the component is automatically replaced or repaired.

For clarification, two examples of possible faults are described below.

In the first exemplary malfunction, a fault occurs in the inlet of a container-processing main or sub-module for labeling due to a defective clamp for holding a container. Due to the defective clamp, the containers cannot continue to be labeled. In this case, the respective container-processing installation can operate in a self-protective manner, as a result of which most errors and malfunctions can be prevented before they occur. If, for example, the clamp shows signs of imminent failure, e.g. decreasing clamping forces, this can be detected by sensors in the container-processing installation and fault information can be sent to the control system. The control system can either indicate to an operator that the clamp needs to be replaced and/or can control a movable service robot for replacing the clamp. For realizing self-healing, the control system can first redirect the container flow, for bypassing the defective clamp, to at least one other container-processing main or sub-module for labeling while the defective clamp is being replaced, e.g. by the service robot. This not only prevents downtime, but in the best case scenario the entire container-processing installation can continue to run at full capacity.

Ideally, operator intervention is also not required. If desired, buffer sections can be dispensed with in the container-processing installation, since the flexible container transport can ensure supply to each module.

In the second exemplary malfunction, a bottle breakage occurs in a container-processing main or sub-module for filling the containers. For example, glass fillers can often break during filling due to excessive temperature gradients. This means that a bottle may shatter during filling and surrounding bottles may also be damaged. The control system can check the containers upstream of the container-processing main or sub-module for filling, for example using suitable sensors and/or database. In this case, for example data on material, temperature and/or filling cycles already completed can be recorded. Preferably, the control system can thus adapt the processing of the container to the recorded data. Thus, for example the heating sub-modules 24 can be used to control, in a self-configuring and self-protecting manner, slower heating of the containers than in normal operation, so that for example stress peaks in the structure can be prevented and the probability of breakage is thus also reduced.

With regard to the ability to be self-explanatory, the container-processing installation can make processed and exchanged data and information available to an operator of the respective container-processing installation, using a user interface. Preferably, every status, every piece of information and every instruction can thus be made available to the operator at the right time and in the right place in a fully understandable manner, in order to be able to understand the operation of the container-processing installation on the one hand and to adapt it manually on the other. Advantageously, simplified usability can lead to lower personnel costs and fewer operating errors. Preferably, an operator can be guided to find solutions and perform corrections when problems occur, as a result of which reduced downtimes and an increase in overall installation effectiveness are possible.

The modules 12-50 and their assemblies can have different levels of autonomy. For example, the modules 12-50 and their assemblies can be configured as (fully) autonomous, partially autonomous or sometimes as non-autonomous modules. The respective structure can depend on various factors, e.g. reusability in other peripherals, procurement/outsourcing of entire functions, costs, technical requirements and constraints, advantages in the production process (assembly, fabrication, commissioning), etc. Preferably, the term “autonomous” in this context means that there is no need for connection to other modules, but with the provision of all media, environmental requirements, aids, etc. required for the function, such as energy/power, data, fluids, fastening/stabilization, consumables, workpieces, etc.

Autonomous modules can make possible the self-configuration described above and optionally also self-organization, self-optimization, self-protection, self-healing and/or self-explanation. Autonomous modules can perform one or more functions either alone or in combination. Accordingly, an autonomous module can have the necessary mechanics, electrical hardware and associated software (including module-specific parameters) for performing the respective task on board ex works or can, for example, request program blocks or data sets or download them from a suitable location. The ability to communicate, request, forward and exchange information, add or uninstall software modules, etc. may be necessary for an exchange from module to module, but also to the operator of the system and also to external systems. This type of consistent data availability is intended to create transparency and simplicity in using the installation, for everyone who interacts with it.

Semi-autonomous modules, which can also be referred to as information-providing modules, can optionally independently perform calculations, control actuators, request information and/or change their configuration, etc. Semi-autonomous modules can advantageously be used as flexible, self-contained units that perform a subtask or provide data for other modules or the higher-level task. For such a subtask or a semi-autonomous module, stand-alone commissioning or autonomous operation is in many cases not possible at all or does not make sense, for example because commissioning is very short and can therefore be done in conjunction or the effort required to simulate the necessary module peripherals is very high. An example of this would be a sensor or evaluation module, wherein the intelligence or logic of an autonomous module initiates certain measures and actions based on the data provided by the module. A gripper attachment that can indicate its type and its previous running time and provides an “open/closed” status signal (on request) could also be such a module.

Non-autonomous modules, which can also be referred to as carrier assemblies/modules, are purely or almost purely mechanical assemblies that, for example, only represent a carrier element and, using a code or data storage device, etc., only provide the most necessary information such as type, part number, date of production, etc. This module type does not fulfill all functions on its own, but can be understood as support for the implementation of a module 12-50.

In addition to the autonomous, semi-autonomous and non-autonomous modules, third-party modules can also be installed in the container-processing installation. These can be procured externally and integrated into the holistically modularized system via a corresponding interface and communicate via this in the same network.

The modular construction system 10 can also significantly simplify conversion or retrofitting after the initial commissioning of the assembled installation. In this case, it should first be taken into account that the individual modules 12-50 may already have a certain degree of variability with regard to the containers that can be transported or handled. For example, all containers of a certain type with a volume between 0.3 I and 1 I can be treated. This variation can preferably be made available purely on the software side, so that, for example, a new bottle format can be switched to at the push of a button. For this purpose, for example a certain number of memory slots may be available ex works, in which the data from the different containers are stored. The number of memory slots can be expandable, depending on requirements.

In addition to the software upgrade, as explained above it may also be necessary to upgrade the hardware, for example for certain container formats or products. For this purpose, the modules 12-50 can be easily coupled to the interfaces 51, 52 as desired, e.g. using mobile robotics, such as the driverless transport vehicle 56, with corresponding tools or by an installation operator on site.

Due to the preferred holistic interfaces 51, 52 (in mechanics, automation/electrics and software) and the ability of self-configuration and, if necessary, self-organization, the modules 12-50 can be exchanged during the product life cycle or the network can be expanded to include new modules and their functions. Reasons for such measures could be a desired increase/reduction in performance (e.g., to adapt an installation to the current market situation), a technology change/addition (e.g., printing instead of labeling or additional PET inner coating), an extension for more product and format flexibility (e.g., a plurality of types at the same time on the same installation), etc.

In this case, such changes in the system can be planned or prepared in advance within the framework of the modular construction system 10. In addition, the modular construction system 10 also makes possible previously unprepared retrofitting of modules 12-50 during the product life cycle.

The graphical user interface is the preferred option for planning the retrofit. Here, for example, feedback can be obtained regarding which hardware and software are necessary for the requested changes. If all mechanical engineering requirements are already in place, the change can also be easily activated using software. Otherwise, corresponding modules 12-50 can be produced and transported to the installation. In this way, not only can an upgrade of the installation itself be carried out, but also—if available—a mobile robotics system (e.g., driverless transport vehicle 56) can be upgraded, which supports or completely takes over processes in the installation.

Thanks to the modular construction system 10, modules 12-50 that are no longer required can also be easily integrated into other installations assembled using the modular construction system 10, and thus reused.

In the embodiment described above, the modular construction system 10 comprises a plurality of container-processing main modules 18-22 and a plurality of container-processing sub-modules 24-44 for equipping the container-processing main modules 18-22. However, it is also possible in principle for the modular construction system 10 to comprise only the container-processing sub-modules 24-44 and, for example, no container-processing main modules 18-22 that can be coupled and uncoupled. In this case, the sub-module interfaces 52 for the container-processing sub-modules 24-44 could be arranged, for example, on the conveyor main module 12 or otherwise.

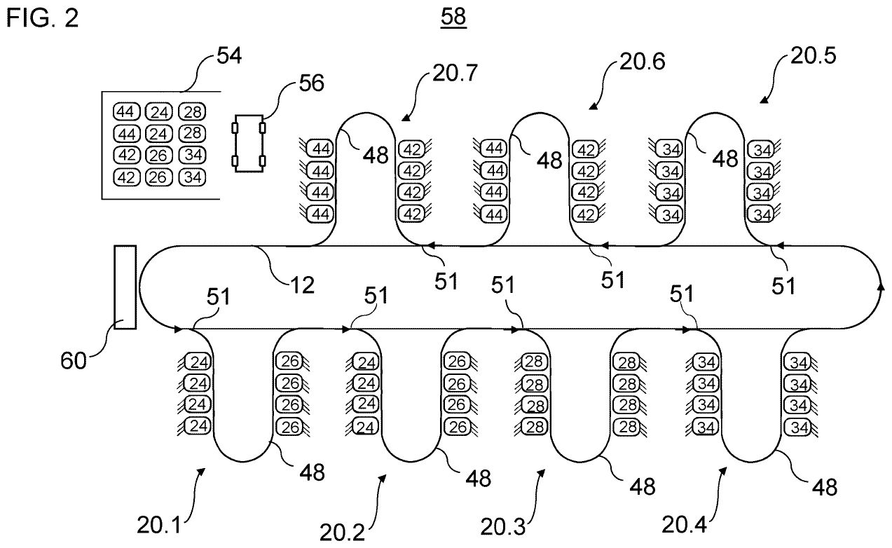

FIGS. 2 to 4 show different container-processing installations that can be constructed, for example, using the modular construction system 10 of FIG. 1.

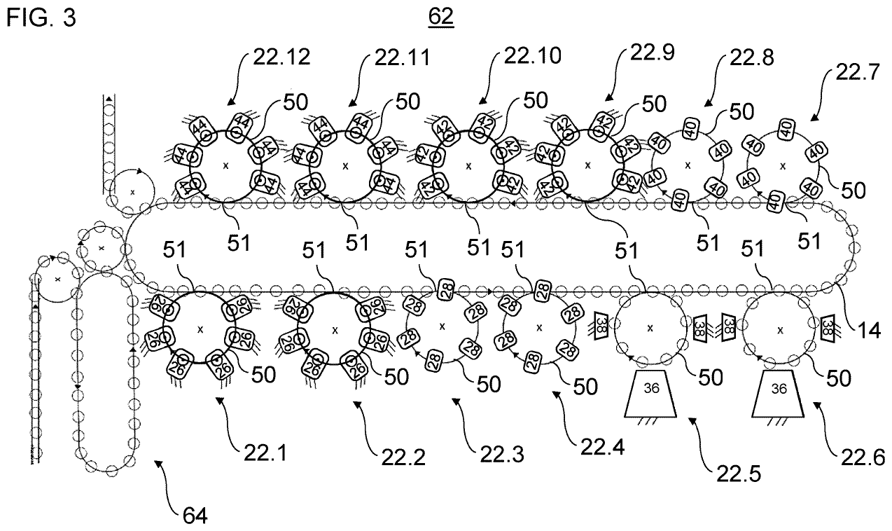

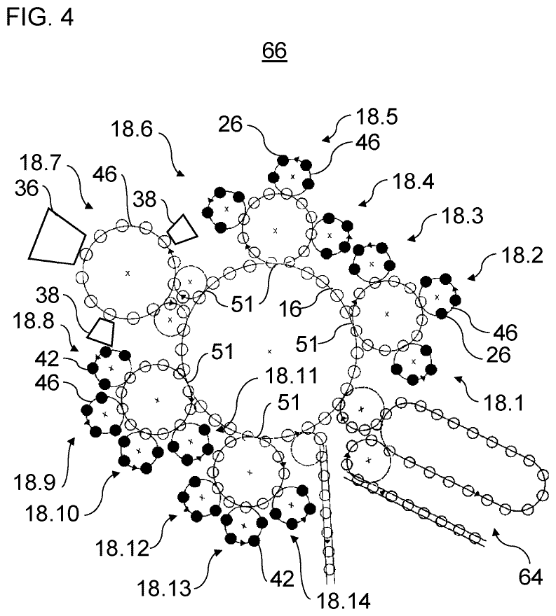

It is understood that even though only the exemplary container-processing system given in FIG. 2 is shown with a parking station 54 and a driverless transport vehicle 56, the container-processing installations of FIG. 3 and FIG. 4 can also comprise a parking station 54 and a driverless transport vehicle 56 if desired.

It is also understood that functions and configurations which are explained below only with respect to one of the container-processing installation of FIGS. 2 to 4 can be implemented equally in the other container-processing installations of FIGS. 2 to 4.

It is further pointed out that the variants shown in FIGS. 2 to 4 are only a selection of possibilities made possible by the modular construction system 10. The variants and combination possibilities of the modular construction system 10 are far greater and can be adapted to the respective customer. In this case it does not matter, for the structure itself, whether the customer wants a full line, a partial line or just individual machines, units or modules. Due to the modular structure, any combination is possible.

In detail, FIG. 2 shows a container-processing installation 58. The container-processing installation 58 can comprise the conveyor main module 12. A plurality of container-processing main modules 20 can be coupled to the main module interfaces 51 of the conveyor main module 12, namely, for example, the container-processing main modules 20.1 to 20.7.

The conveyor sub-modules 48 of the container-processing main modules 20.1 to 20.7 are each configured or arranged as bypass sections for different portions of the conveyor main module 12. From the main transport path, which is predefined by the conveyor main module 12, the containers are diverted for a respective processing via the conveyor sub-modules 48 arranged as bypasses and, after the processing, are directed back to the main transport path or the conveyor main module 12.

In the configuration shown by way of example, the container-processing installation 58 can perform the functions of heating, molding/production, cooling, printing, filling and closing. Processing steps that are closely linked can be carried out one after the other in the same container-processing main module 20.1 to 20.7, if desired. This coupling of different processing steps can be carried out, for example, during heating and molding (see container-processing main modules 20.1 and 20.2) and/or during filling and closing (see container-processing main modules 20.6 and 20.7).

The container-processing main modules 20.1 and 20.2 can be configured as container-producing main modules for producing containers. The container-processing main modules 20.1 and 20.2 can each comprise a plurality of heating sub-modules 24 and molding sub-modules 26.

The container-processing main module 20.3 can be configured as a container cooling main module for cooling the containers. The container-processing main module 20.3 can comprise a plurality of cooling sub-modules 28.

The container-processing main modules 20.4 and 20.5 can be configured as container equipping main modules for equipping the containers. The container-processing main modules 20.4 and 20.5 can each comprise a plurality of printing sub-modules 34 (and/or labeling sub-modules 36—not shown).

The container-processing main modules 20.6 and 20.7 can be configured as container filling and closing main modules. The container-processing main modules 20.6 and 20.7 can each comprise a plurality of filling sub-modules 42 and a plurality of closing sub-modules 44.

The arrangement of the container-processing main modules 20.1 to 20.7 is purely by way of example. For example, the container-processing main modules 20.4 and 20.5 configured as container equipping main modules can be arranged downstream of the container-processing main modules 20.6 and 20.7 configured as container closing main modules.

The container-processing installation 58 can comprise the parking station 54 and the driverless transport vehicle 56 for transporting the container-processing main modules 20.1 to 20.7 and/or the container-processing sub-modules 24-44 between the parking station 54 and the respective main and sub-module interfaces 51, 52 (see also FIG. 1).

Optionally, the container-processing installation 58 can, for example, also comprise a preform feed 60. Using the preform feed 60, preforms for the containers can be transported to the conveyor main module 12 and transferred to it.

During operation of the container-processing installation 58, preforms can be fed to the conveyor main module 12 via the preform feed 60 and discharged via one of the two container-processing main modules 20.1 and 20.2, heated in the heating sub-modules 24 and molded into containers in the molding sub-modules 26. The containers produced are transferred from the conveyor sub-modules 48 back to the conveyor main module 12.

Via sensory temperature detection, containers that are hotter than a predefinable limit value can be diverted to the container-processing main module 20.3 for cooling using the cooling sub-modules 28 and returned to the conveyor main module 12 after cooling. Alternatively, containers whose temperature is below the predefinable limit value or within a target range can be transported further on the conveyor main module 12, without being diverted to the container-processing main module 20.3.

Subsequently, the processing steps of printing in the container-processing main modules 20.4 and 20.5, as well as filling and closing in the container-processing main modules 20.6 and 20.7, can be carried out. In this case, the containers can be distributed equally between the container-processing main modules 20.4 and 20.5 and between the container-processing main modules 20.6 and 20.7.

In the parking station 54, unused container-processing sub-modules 24-44 can be temporarily stored and, if required, fed for coupling to the interfaces 52 using the driverless transport vehicle 56. Since, as mentioned, the control system is inter alia self-configuring, the coupling and uncoupling of the container-processing sub-modules 24-44 can be carried out without a setup process and the operation of the container-processing installation 58 can be automatically adapted accordingly.

Depending on, for example, production order information received from the control system of the container-processing installation 58, the composition of the entire container-processing installation 58, i.e. the automatic coupling and uncoupling of the modules 12-44, can be carried out on a self-organizing and self-optimizing basis in order to achieve the best possible production. Using fault information received by the control system of the container-processing installation 58, defective components or modules 12-44 can be detected (early) and replaced or repaired before, for example, a fault or damage can occur in the entire container-processing installation 58. This allows the container-processing installation 58 to also be capable of self-protection and self-healing.

FIG. 3 shows a container-processing installation 62.

With the container-processing installation 62, for example the conveyor main module 14 configured as a conveyor belt, and the processing main modules 22.1-22.12 with the conveyor sub-modules 50 configured as a carousel can be used.

The container-processing main modules 22.1 and 22.2 can be configured as container-producing main modules for producing the containers. The container-processing main modules 22.1 and 22.2 can each comprise a plurality of molding sub-modules 26.

The container-processing main modules 22.3 and 22.4 can be configured as container cooling main modules for cooling the containers. The container-processing main modules 22.3 and 22.4 can each comprise a plurality of cooling sub-modules 28.

The container-processing main modules 22.5 and 22.6 can be configured as container equipping main modules for equipping the containers. The container-processing main modules 22.5 and 22.6 can each comprise at least one testing sub-module 38 and at least one labeling sub-module 36.

The container-processing main modules 22.7 and 22.8 can be configured as cleaning main modules for cleaning the containers. The container-processing main modules 22.7 and 22.8 can each comprise a plurality of cleaning sub-modules 40.

The container-processing main modules 22.9 and 22.10 can be configured as container filling main modules. The container-processing main modules 22.9 and 22.10 can each comprise a plurality of filling sub-modules 42.

The container-processing main modules 22.11 and 22.12 can be configured as container closing main modules. The container-processing main modules 22.11 and 22.12 can each comprise a plurality of closing sub-modules 44.

The arrangement of the container-processing main modules 22.1 to 22.12 is purely by way of example. For example, the container-processing main modules 22.5 and 22.6 configured as container equipping main modules can be arranged downstream of the container-processing main modules 22.11 and 22.12 configured as container closing main modules.

During operation of the container-processing installation 62, continuous transport of the containers can be provided via the conveyor main module 14. The container flow can be distributed as required over the container-processing main modules 22.1 to 22.12, as a result of which, for example, optimal capacity utilization is possible. During distribution, the continuous container flow can be taken over from the container-processing main modules 22.1 to 22.12, for example using clamps, and transferred back to the conveyor main module 14.

The container-processing installation 62 also shows the integration of a conventional preform heating apparatus 64 upstream of the conveyor main module 14, through which all preforms pass.

FIG. 4 shows a container-processing installation 66.

With the container-processing installation 66, for example, the conveyor main module 16 configured as a carousel and the container-processing main modules 18.1-18.14 with the conveyor sub-modules 46 configured as satellites (carousels), which are not all provided with a separate reference sign in FIG. 4 for reasons of clarity, can be used. The container-processing main modules 18.1-18.14 are connected to the conveyor main module 16 via transport stars.

The container-processing main modules 18.1 to 18.6 can be configured as container-producing main modules for producing the containers. The container-processing main modules 18.1 to 18.6 can each comprise a plurality of molding sub-modules 26, which are not all provided with a separate reference sign in FIG. 4 for reasons of clarity. The container-processing main modules 18.1 to 18.3 can share a transport star that connects them to the main conveying module 16. Likewise, the container-processing main modules 18.4 to 18.6 can share a transport star that connects them to the conveyor main module 16.

The container-processing main module 18.7 can be configured as a container equipping main module for equipping the containers. The container-processing main module 18.7 can comprise at least one testing sub-module 38 and at least one labeling sub-module 36. It is possible that the labeling sub-module 36 is interchangeable with a printing sub-module 34, for example. The container-processing main module 18.7 can be connected to the main conveying module 16 via an inlet star and an outlet star.

The container-processing main modules 18.8 to 18.14 can be configured as container filling main modules. The container-processing main modules 18.8 to 18.14 can each comprise a plurality of filling sub-modules 42, which are not all provided with a separate reference sign in FIG. 4 for reasons of clarity. The container-processing main modules 18.8 to 18.11 can share a transport star that connects them to the conveyor main module 16. Likewise, the container-processing main modules 18.12 to 18.14 can share a transport star that connects them to the conveyor main module 16. It is possible that the container-processing main modules 18.12 to 18.14 are configured as container closing main modules, each of which comprises a plurality of closing sub-modules 44 (not shown).

The arrangement of the container-processing main modules 18.1 to 18.14 is purely by way of example. For example, the container-processing main module 18.7 configured as a container equipping main module can be connected to the conveyor main module 16 downstream of the container-processing main module 18.14.

With reference to FIGS. 2 to 4, some aspects of an exemplary production operation of the container-processing installation 58, 62, 66 are described below.

During operation, an operator can access all relevant production data at any time via central displays, head-up displays, data glasses, tablets, etc. Material supply, production, process optimization, logistics, etc. can be integrated and run without manual intervention.

Sensors in the container-processing installations 58, 62, 66 can monitor relevant key data and identify, for example, wear, productivity losses, malfunctions, process fluctuations, etc.

In this connection, failure probabilities can be determined, for example, by comparing them with a digital twin. If, for example, a predefined threshold is exceeded or not reached, the control system can issue a notification with instructions for intervention or, optionally, automatically order spare parts, lubricants, etc. The digital twin is preferably synchronized on a daily basis with the physical container-processing installation 58, 62, 66. The evaluation of all data is carried out using artificial intelligence, for example. The data sets from a plurality of delivered installations can serve as a basis for continuous optimization, including of the digital twins, and thus the continuous improvement of the process parameters in each module 12-50.

Due to this approach and the continuously growing knowledge base, the modules 12-50 and their network can optimally deal with faults. Foreseeable error conditions can be avoided or their elimination can be prepared and processed in the best possible way, preferably fully automatically. For example, corresponding robot technology can be used for this purpose, or faults can be remedied by the operator using self-explanatory instructions from the respective module 12-50, e.g. the provision and refilling of consumables just in time, wear part failure, etc.

In the case of unforeseeable errors, the correction can be carried out immediately as far as possible. For example, if a software crash occurs on a module, an automatic reboot routine can be loaded without stopping production. It is also possible to put the installation into a safe state and, for example, issue a recommendation for action to the operator.

For example, a faulty module 12-50 can automatically uncouple from the respective main or sub-module interface 51 or 52. The installation can then advantageously continue to produce, for example at reduced output. Using the knowledge base, it could then be determined, for example, that in the current error case a leak was 92% of the cause, and which connector should be checked/replaced.

A preferably self-organizing sequence of the overall production process allows the container-processing installations 58, 62, 66 to react quickly to changes in the production plan and, with the corresponding setup of modules 12-50, to also process different products in different containers. With a direct software coupling to the associated production planning system, it is also conceivable, for example, that the advancement of an urgent order can be predefined, the planning takes place fully automatically, the container-processing installations 58, 62, 66 adapt or adjust themselves accordingly, and the installation operator is informed what he has to do and how so that the prioritized order is completed on time.

It is also possible for an operator to decide during operation which digital functions or features he would like to use. For this purpose, he preferably has an overview of all the options available with the respective container-processing installation 58, 62, 66 in the graphical user interface already explained, and can directly add, install and, if necessary, remove, corresponding additional programs and plug-ins (e.g., various process optimization programs, self-healing programs, type storage slots when using customizable fitting parts, etc.). The customer can also use this method to submit suggestions for improvements to his container-processing installation 58, 62, 66 at any time, so that the entire installation configuration can be optimized according to customer criteria and objectives (maximum overall equipment effectiveness, energy-saving, longevity, etc.) and all potentials can be exploited.

FIG. 5 shows an exemplary communication network 68, in which the modules 12-50 can be integrated, as explained below, by way of example, on the basis of some modules.

The communication network 68 can include various modules 12-50 (only some of which are shown), communication links 70 and a central data source (central data storage) 72. Optionally, the communication network 68 can, for example, also comprise a packing module 74 for packing the containers.

Preferably, in the communication network 68, the individual modules 12-50 are equal participants and have the same access rights. Each participant hears and speaks in the communication network 68 or can receive data via the communication network 68 and send data via the communication network 68. Inquiries that are made in the communication network 68 can, for example, be answered directly. Preferably, the respective communication partners find each other independently. The exchange of data can preferably take place in a manufacturer-specific language.

The various modules 12-50 can be connected to each other and to the central data source 72 via the communication connections 70. The communication connections 70 can be implemented as wireless and/or wired connections. The modules 12-50 and the central data source 72 can exchange information in the form of data via the communication links 70. The modules 12-50 and the central data source 72 can each send and receive data via the communication connections 70.

The central data source 72 can, as already mentioned, be part of the control system of the respective container-processing installation. The central data source 72 can preferably be configured as a data storage platform without its own control logic component or the like. It is possible that the central data source 72 can communicate via a communication interface for example with a cloud or a server of the manufacturer of the respective container-processing installation.

Different data can be stored in the central data source 72. The data can be stored in a so-called data table or in another way. The data can for example be divided into a plurality of categories, e.g. type or product-dependent data, production-dependent data, and installation data or line data.

The type-dependent data can be data that relate to the product to be processed or produced, e.g. container size, preform material, filling material/medium to be filled, etc.

The production-dependent data, on the other hand, can contain information that is not tied to the product(s) and is used for production planning and coordination, such as production output, ambient temperatures, etc.

The type-dependent and production-dependent data can substantially be received or entered from outside, e.g. via the cloud, the commissioning engineer or the operator. The individual modules 12-50 can retrieve the data for use. The modules 12-50 can also send feedback to the central data source 72 (e.g., learnings).

The modules can store 12-50 pieces of information in the installation data. This can preferably be information that concerns the entire system, i.e. the respective container-processing installation, e.g. fault information, product order information or profiles of the individual modules 12-50.

Storing data in the central data source 72 is preferably carried out via a standard mask. This ensures that the relevant data are always stored in the same place and can be retrieved from there. The modules 12-50 independently retrieve the data they need for production and interaction within the network. Should an update take place during production or relevant data become available, the modules 12-50 can also independently query this information from the central data source 72.

It is possible that higher priority data that requires immediate action, such as a fault or emergency stop, can be sent as a (push) notification to modules 12-50.

Preferably, all necessary master data that are required for pure task processing can be stored in the respective module that can fulfill the task. These data can include, for example, information about capabilities, reactions, maintenance intervals, etc. These data can be individual for each variant of the modules 12-50, e.g. the type of filler/filling process, and can be transferred to the module before the respective module 12-50 is delivered. It is also possible to update or change these data via the cloud or a manufacturer's server.

Preferably, the modules 12-50 can also make prioritized method calls, such as in the event of a fault, whereupon direct feedback must be provided to a specific participant in the communication network 68. As already mentioned, these messages can be sent to the relevant participants via (push) notifications so that they can react immediately.

A further type of data of the modules 12-50 can be cooperation data, which the respective module 12-50 continuously transmits to the communication network 68 during production.

Preferably, prefabricated communication protocols and method calls, in which the corresponding parameters can be stored in an orderly manner before sending, can simplify the data exchange. The type-dependent and production-dependent data can be retrieved module-specifically from the modules 12-50 during initialization of the respective container-processing installation, and stored temporarily until updated or overwritten.

Fault information about a scrap rate exceeding limits can preferably be forwarded directly to the respective module 12-50, which can counteract the detected deterioration, until a critical scrap quantity is exceeded. Only if the problem cannot be resolved in this way can global fault information be transmitted to the communication network 68.

The container-processing installations 58, 62, 66 described herein by way of example are suitable, for example, for the flexible production of a very wide variety of products in the low to medium performance range. This means that requirements such as an installation next to or as part of a supermarket or an installation for products with different versions, labels, closures, etc. can be very well covered by the concept, even though the variety of variants in all product properties is large and the fluctuating demand across seasons and production years may be difficult to plan. Furthermore, the possibility of autonomous module operation and the corresponding interfaces allow functional units to be used in different peripherals, from stand-alone to cycle machine to high-performance operation with continuous container flow. Examples of such universally applicable functional modules would be autonomous filling valves, internal coating stations, labeling units, printing technology units, etc. Preferably, the concept presented can offer a flexible, technologically high-quality and future-proof solution for all requirement profiles.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the conveyor main module, the plurality of sub-module interfaces, the plurality of container-processing sub-modules, and/or the control system of independent claim 1.

### LIST OF REFERENCE SIGNS

10 modular construction system
12-16 conveyor main modules
18-22 container-processing main modules
24-44 container-processing sub-modules
46-50 conveyor sub-modules
51 main module interface
52 sub-module interface
54 parking station
56 driverless transport vehicle
58 container-processing installation
60 preform feed
62 container-processing installation
64 preform heating apparatus
66 container-processing installation
68 communication network
70 communication connections
72 central data source
74 packing module

1. A modular container-processing installation comprising:
a conveyor main module, which is arranged for conveying containers through the modular container-processing installation
a plurality of sub-module interfaces
a plurality of container-processing sub-modules, which can be coupled to and uncoupled from the plurality of sub-module interfaces using a driverless transport vehicle; and
a control system which, in a self-configuring manner, is configured to automatically adapt the operation of the modular container-processing installation; depending on at least one of a coupling of at least one of the plurality of container-processing sub-modules to at least one of the plurality of sub-module interfaces, and an uncoupling of at least one of the plurality of container-processing sub-modules from at least one of the plurality of sub-module interfaces.

2. The modular container-processing installation according to claim 1, further comprising:
a plurality of container-processing main modules which can be coupled to and uncoupled from a plurality of main module interfaces of the conveyor main module; using a driverless transport vehicle, wherein the plurality of container-processing main modules each comprise:
at least one of the plurality of sub-module interfaces; and
a conveyor sub-module connected or connectable to the conveyor main module for receiving the containers from the conveyor main module and for transferring the containers back to the conveyor main module.

3. The modular container-processing installation according to claim 1, wherein the control system is configured:
to receive production order information for handling the containers; and
to automatically adapt at least one of the operation of the modular container-processing installation and a respective coupling and uncoupling of the plurality of container-processing sub-modules to the plurality of sub-module interfaces depending on the received production order information.

4. The modular container-processing installation according to claim 1, wherein the control system is configured at least one of:
when automatically adapting the operation, to generate a movement path of the containers through the modular container-processing installation including at least a portion of the plurality of container-processing sub-modules and to control a movement of the containers in accordance with the generated movement path;
when automatically adapting the operation, to adapt operating parameters of at least one of the conveyor main module and the plurality of container-processing sub-modules; and
to automatically adapt at least one of the operation and the respective coupling and uncoupling depending on empirical data in which previous operations of at least one of the modular container-processing installation and other container-processing installations are stored.

5. The modular container-processing installation according to claim 2, also comprising:
a parking station; and
a driverless transport vehicle for transporting at least one of the plurality of container-processing sub-modules between the parking station and the plurality of sub-module interfaces.

6. The modular container-processing installation according to claim 5, wherein:
the control system is configured to control, depending on received production order information, using the driverless transport vehicle, a transport of at least one of the plurality of container-processing sub-modules between the parking station and at least one of the plurality of sub-module interfaces for coupling or uncoupling the respective container-processing sub-module.

7. The modular container-processing installation according to claim 5, wherein:
the control system is configured to control, depending on received production order information, using the driverless transport vehicle, a transport of at least one of the plurality of container-processing main modules between the parking station and at least one of the plurality of main module interfaces for coupling or uncoupling the respective container-processing main module

8. The modular container-processing installation according to claim 1, wherein the control system is configured to at least one of generate and receive fault information indicating a predicted or current defect of a component and, depending on the fault information, at least one of:
to control at least one of an automatic repair or replacement of the component and a software code assigned to the component;
to automatically adapt the operation of the modular container-processing installation such that at least one of the component is bypassed by the containers and a software code assigned to the component is bypassed; and
to control an automatic uncoupling of the container-processing sub-module which comprises the component.

9. The modular container-processing installation according to claim 1, wherein the plurality of container-processing sub-modules comprise at least one of:
at least one labeling sub-module for labeling the containers;
at least one testing sub-module for testing the containers;
at least one printing sub-module for printing on the containers;
at least one cleaning sub-module for cleaning the containers;
at least one filling sub-module for filling the containers;
at least one closing sub-module for closing the containers;
at least one heating sub-module for heating preforms of the containers;
at least one molding sub-module for molding the containers from preforms;
at least one turning sub-module for turning the containers;
at least one cooling sub-module for cooling the containers;
at least one coating sub-module for coating the containers;
at least one pasteurization module for pasteurizing the containers;
at least one drying module for drying the containers;
at least one grouping module for grouping the containers;
at least one packing module for packing the containers;
at least one palletizing module for palletizing the containers;
at least one depalletizing module for depalletizing the containers;
at least one unpacking module for unpacking the containers; and
at least one dating module for dating the containers.

10. The modular container-processing installation according to claim 2, wherein at least one of:
at least one testing sub-module and at least one labeling sub-module and printing sub-module are included, which are jointly coupled to a plurality of sub-module interfaces of one of the plurality of container-processing main modules;
a plurality of filling sub-modules and a plurality of closing sub-modules are included, which are jointly coupled to a plurality of sub-module interfaces of one of the plurality of container-processing main modules; and
a plurality of heating sub-modules and a plurality of molding sub-modules are included, which are jointly coupled to a plurality of sub-module interfaces of one of the plurality of container-processing main modules.

11. The modular container-processing installation according to claim 1, wherein:
the control system comprises a plurality of decentralized control units associated to at least one of the conveyor main module and the plurality of container-processing sub-modules, and a central data source; and
the plurality of decentralized control units and the central data source are configured to jointly coordinate the adaptation of the operation of the modular container-processing installation when at least one of coupling and uncoupling one of the plurality of container-processing sub-modules for self-configuration of the control system.

12. The modular container-processing installation according to claim 1, wherein at least one of:
the plurality of sub-module interfaces each comprises at least one of an electrical connection, a communication connection, a fluid connection and a mechanical connection; and
the plurality of sub-module interfaces are identical in construction.

13. The modular container-processing installation according to claim 1, wherein at least one of the following features is fulfilled:
the conveyor main module is arranged centrally in the container-processing installation;
the conveyor main module is configured as a transport carousel, as a long stator or short stator linear drive conveyor, as a planar drive conveyor, as a belt conveyor, or as a neck handling conveyor; and
the plurality of container-processing sub-modules is arranged in a manner distributed around the conveyor main module.

14. A method for producing a modular container-processing installation using a modular construction system, comprising:
selecting a conveyor main module from a plurality of different conveyor main modules of the modular construction system, wherein:
the plurality of different conveyor main modules can each be arranged for conveying containers through the modular container-processing installation; and
the plurality of different conveyor main modules each comprises a plurality of main module interfaces;
selecting a plurality of container-processing main modules from a plurality of different container-processing main modules of the modular construction system, wherein:
the plurality of different container-processing main modules can be coupled to the plurality of main module interfaces;
the plurality of different container-processing main modules each comprises a plurality of sub-module interfaces; and
the plurality of different container-processing main modules each comprises a conveyor sub-module which is connectable to the selected conveyor main module for receiving the containers from the selected conveyor main module and for transferring the containers back to the selected conveyor main module;
selecting a plurality of container-processing sub-modules from a plurality of different container-processing sub-modules of the modular construction system, wherein:
the plurality of different container-processing sub-modules can be coupled to the plurality of sub-module interfaces;
assembling the modular container-processing installation from the selected conveyor main module, the selected main container-processing modules and the selected container-processing sub-modules.

15. The method for operating the modular container-processing installation according to any of claim 1, comprising:
automatically adapting an operation of the modular container-processing installation using self-configuration of the control system depending on at least one of a coupling and uncoupling of at least one of the plurality of container-processing sub-modules.

16. The method according to claim 15, further comprising automatically adapting an operation of the modular container-processing installation by self-configuring the control system depending on at least one of a coupling and uncoupling of at least one of the plurality of container-processing main modules.

17. The method according to claim 14, wherein at least one of:
the conveyor main module is selected using a graphical user interface;
the plurality of container-processing main modules is selected using the graphical user interface;
the plurality of container-processing sub-modules is selected using the graphical user interface; and
the modular container-processing installation includes:
the conveyor main module, which is arranged for conveying containers through the modular container-processing installation,
the plurality of sub-module interfaces,
the plurality of container-processing sub-modules, which can be coupled to and uncoupled from the plurality of sub-module interfaces using a driverless transport vehicle, and
a control system which, in a self-configuring manner, is configured to automatically adapt the operation of the modular container-processing installation depending on at least one of a coupling of at least one of the plurality of container-processing sub-modules to at least one of the plurality of sub-module interfaces, and an uncoupling of at least one of the plurality of container-processing sub-modules from at least one of the plurality of sub-module interfaces.

18. The modular container-processing installation according to claim 1, wherein at least one of:
the plurality of container-processing sub-modules can be coupled to and uncoupled from the plurality of sub-module interfaces automatically using the driverless transport vehicle;
the plurality of container-processing main modules can be coupled to and uncoupled from the plurality of main module interfaces of the conveyor main module automatically using the driverless transport vehicle;
the control system is further self-configuring for automatically adapting an operation of the modular container-processing installation depending on at least one of the coupling of at least one of the plurality of container-processing main modules to at least one of the plurality of main module interfaces and on the uncoupling of at least one of the plurality of container-processing main modules from at least one of the plurality of main module interfaces;
the control system includes a central data source with variety-dependent data, production-dependent data and system data stored in the central data source; and
the plurality of container-processing sub-modules includes at least one molding sub-module for molding the containers from preforms using stretch blowing.

19. The modular container-processing installation according to claim 8, wherein the operation of the modular container-processing installation is automatically adapted such that the at least one of the component is bypassed by the containers and the software code assigned to the component is bypassed while at least one of the component and the software code assigned to the component is automatically replaced or repaired.

20. The modular container-processing installation according to claim 10, wherein at least one of:
the at least one testing sub-module and the at least one labeling sub-module and printing sub-module are jointly coupled to the plurality of sub-module interfaces of the one of the plurality of container-processing main modules for forming a container equipping main module;
the plurality of filling sub-modules and the plurality of closing sub-modules are jointly coupled to the plurality of sub-module interfaces of the one of the plurality of container-processing main modules for forming a container filling and closing main module; and
the plurality of heating sub-modules and the plurality of molding sub-modules are jointly coupled to the plurality of sub-module interfaces of the one of the plurality of container-processing main modules for forming a container-producing main module.
